(19) United States
(12) Patent Application Publication
(10) Pub. No.: US 2006/0266182 A1
(43) Pub. Date: Nov. 30, 2006

(54) Fence extension for power saws

(76) Inventor: Shiraz Balolia, Bellingham, WA (US)

Correspondence Address: SCHACHT LAW OFFICE, INC., SUITE 202, 2801 MERIDIAN STREET, BELLINGHAM, WA, 98225-2412, US

(21) Appl. No.: 11/129,239

(22) Filed: May 12, 2005

(51) Int. Cl. B27B 27/06; B27B 5/18

(52) U.S. Cl. 83/471.3

(57) ABSTRACT

A fence extension assembly for extending a height dimension of a table fence assembly, comprising an extension fence member, a lock plate, and a lock member. The extension fence member defines a guide surface, a lock wall, a lock cavity, and a lock slot formed in the lock wall to allow access to the lock cavity. The lock plate is arranged within the lock cavity. The lock member is adapted to extend through a mounting passageway in the table fence assembly and into the lock slot. The lock member engages the lock plate to rigidly secure the extension fence member to the table fence assembly.

### TECHNICAL FIELD

The present invention relates fence extensions for power saws and, more specifically, to systems and methods for extending the height of a fence arranged to guide a workpiece relative to a saw blade.

### BACKGROUND OF THE INVENTION

The present invention relates to band saws used for cutting a workpiece. Although the present invention is of particular significance when used in conjunction with a bandsaw, the present invention may have application to other types of saws having a fixed table and a fence to help guide the workpiece relative to a blade.

A band saw comprises a fixed table and blade in the form of a band that passes over an upper wheel above the table and below a lower wheel below the table. The blade passes through a slot in the table. Rotation of one of the wheels displaces the blade relative to the table. The workpiece is supported by the table and displaced relative to the blade such that the blade forms a desired cut.

In a typical band saw, the blade is laterally supported by lower guide rollers below the surface of the table and upper guide rollers above the workpiece. The upper guide rollers typically can be raised and lowered such that the blade is supported as close as possible to the workpiece to inhibit flexing of the blade between the upper guide rollers and the workpiece. Such flexing may otherwise cause the blade to “wander” through the workpiece, resulting in an inaccurate cut.

Numerous saw accessories are provided to facilitate formation of the desired cut. The present invention relates to a fence assembly that is supported adjacent to the blade. The workpiece may be held against a guide surface of the fence assembly while the cut is being made. The fence helps the saw make a straight cut at a desired location on the workpiece. In a conventional band saw, the fence is fairly short to allow the upper guide rollers to be lowered to a point just above a short workpiece.

The present invention generally relates to improved fence assemblies for power saws and, more specifically, to fence assemblies for band saws that facilitate the cutting of relatively tall workpieces.

### SUMMARY OF THE INVENTION

The present invention may be embodied as a fence extension assembly for extending a height dimension of a table fence assembly. The fence extension assembly of the present invention comprises an extension fence member, a lock plate, and a lock member. The extension fence member defines a guide surface, a lock wall, a lock cavity, and a lock slot formed in the lock wall to allow access to the lock cavity. The lock plate is arranged within the lock cavity. The lock member is adapted to extend through a mounting passageway in the table fence assembly and into the lock slot. The lock member engages the lock plate to rigidly secure the extension fence member to the table fence assembly.

### BRIEF DESCRIPTION OF THE DRAWINGS

FIG. 1 is a perspective view of an example extension assembly of the present invention mounted onto a conventional saw assembly;

FIG. 2 is an exploded view of the extension assembly of FIG. 1 in relation to an example saw assembly;

FIG. 3 is an end, partial cut-away view of the extension assembly taken along lines 3-3 in FIG. 1;

FIG. 4 is a top plan, partial cut-away view of the extension assembly taken along lines 4-4 in FIG. 1;

FIG. 5 is a side elevation, cut-away, exploded view of the extension assembly of FIG. 1; and

FIGS. 6 and 7 are front elevation views depicting the operation of a band saw assembly in a first mode without the fence extension assembly and in a second mode with the fence extension assembly, respectively.

### DETAILED DESCRIPTION OF THE INVENTION

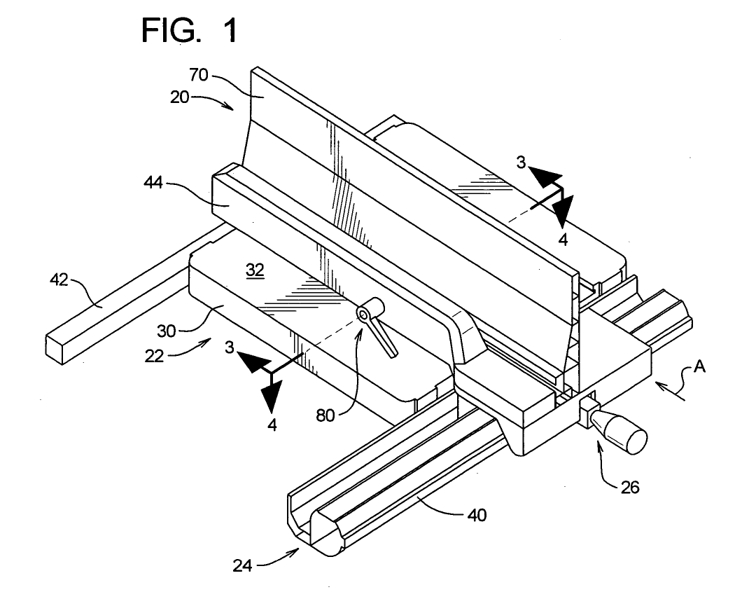

Referring to the drawing, depicted therein is an example extension fence assembly 20 constructed in accordance with, and embodying, the principles of the present invention. The example fence extension fence assembly 20 is illustrated in FIGS. 1-4 and 7 in the context of a band saw assembly generally depicted at 22. In particular, the extension fence assembly 20 is supported by a table fence assembly 24 also forming part of the band saw system 22. A fence lock assembly 26 secures the table fence assembly 24 relative to the band saw system 22.

The band saw system 22, table fence assembly 24, and table lock assembly 26 all are or may be conventional and are not per se part of the present invention. One aspect of the construction and operation of the extension fence assembly 20 is that it can be adapted for use with table assemblies, fence assemblies, and lock assemblies of many different sizes and configurations. The band saw system 22, table fence assembly 24, and table lock assembly 26 will thus be described below only to the extent necessary for a complete understanding of the present invention.

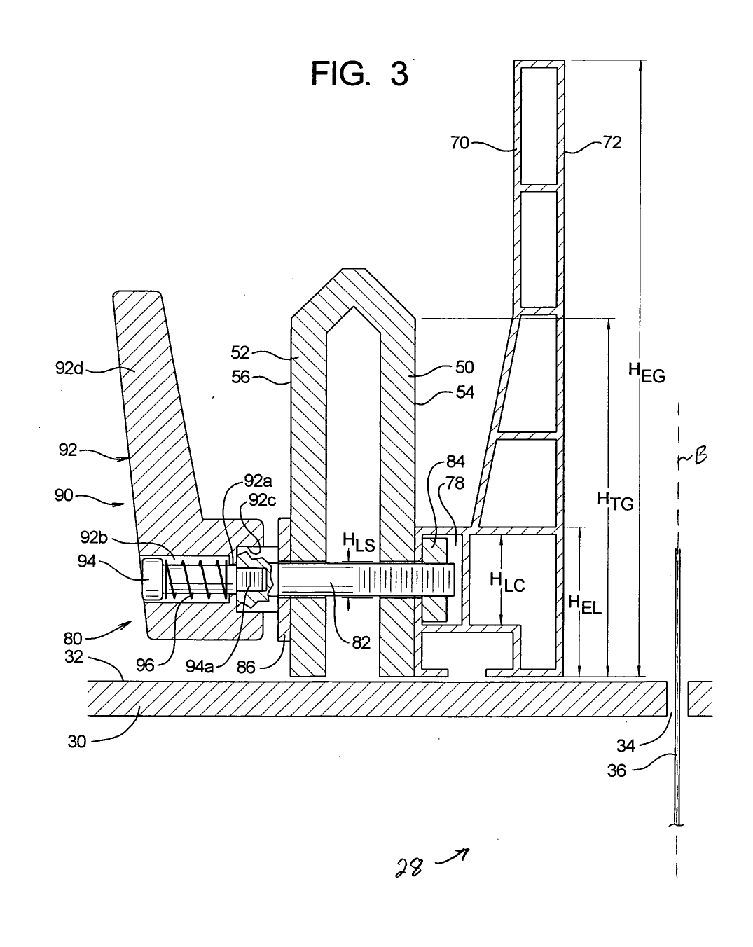

The band saw system 22 comprises a table member 30 defining a table surface 32. The table member 30 further defines a blade slot 34 (FIG. 3) through which a blade 36 extends. The blade 36 also forms part of the band saw system 22. The extension fence assembly 20 of the present invention will typically be used with a table assembly forming part of a band saw, and the example blade 36 is a band saw blade.

The table fence assembly 24 comprises a first rail member 40, a second rail member 42, and a table fence member 44. The rail members 40 and 42 are rigidly secured to the table member 30 and extend in a direction substantially orthogonal to a cutting direction A along which a workpiece is displaced relative to the blade 36 during cutting. The table fence member 44 is supported by the rail members 40 and 42 slightly above the table surface 32 and extends in a direction that is substantially parallel the cutting direction A. The blade 36 defines a blade axis B that is substantially orthogonal to the cutting direction A.

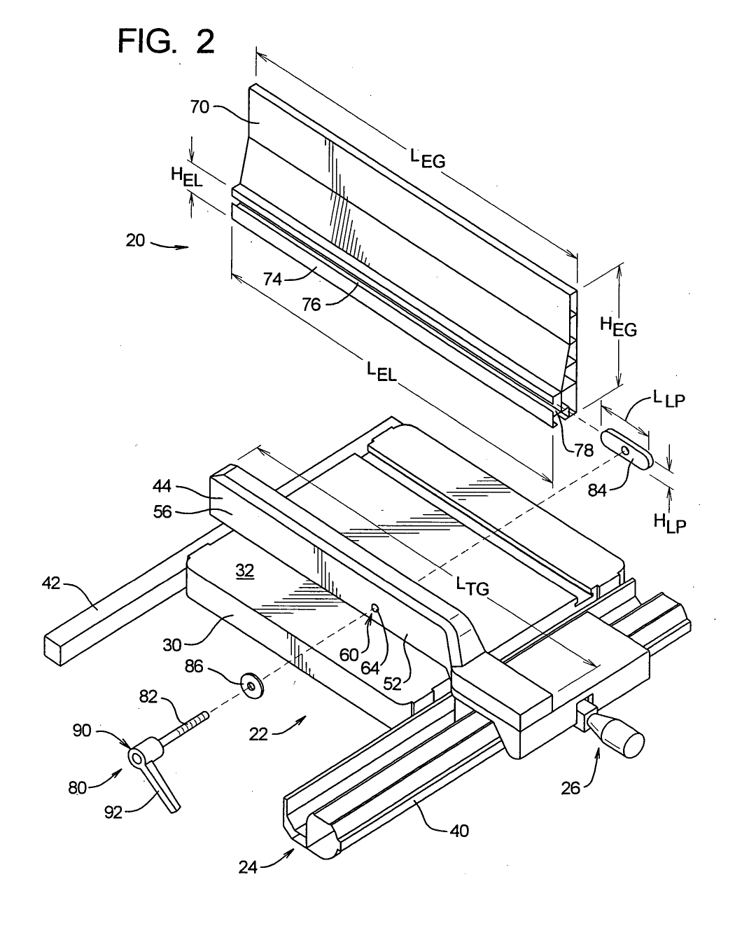

As shown in FIGS. 2 and 3, the example table fence member 44 takes the form of an inverted “U” and defines first and second guide walls 50 and 52. The first and second guide walls 50 and 52 in turn define first and second guide surfaces 54 and 56, respectively.

As is conventional, the fence member 44 is arranged at a desired location relative to the blade 36 and locked into position using the fence lock assembly 26. During cutting, a workpiece is placed on the table surface 32, held against one of the guide surfaces 54 and 56, and displaced such that the blade 36 makes a desired cut in the workpiece. The fence member 44 can be arranged on either side of the blade 36 such that workpiece is held against either one of the guide surfaces 54 and 56. When the fence member 44 is arranged as shown in FIGS. 1-4, the workpiece will be held against the first guide surface 54.

A mounting passage 60 is formed by first and second mounting openings 62 and 64 formed in the first and second guide walls 50 and 52, respectively. As will be described below, the mounting passageway 60 allows the extension fence assembly 20 to be mounted onto the fence assembly 24 as will be described in further detail below.

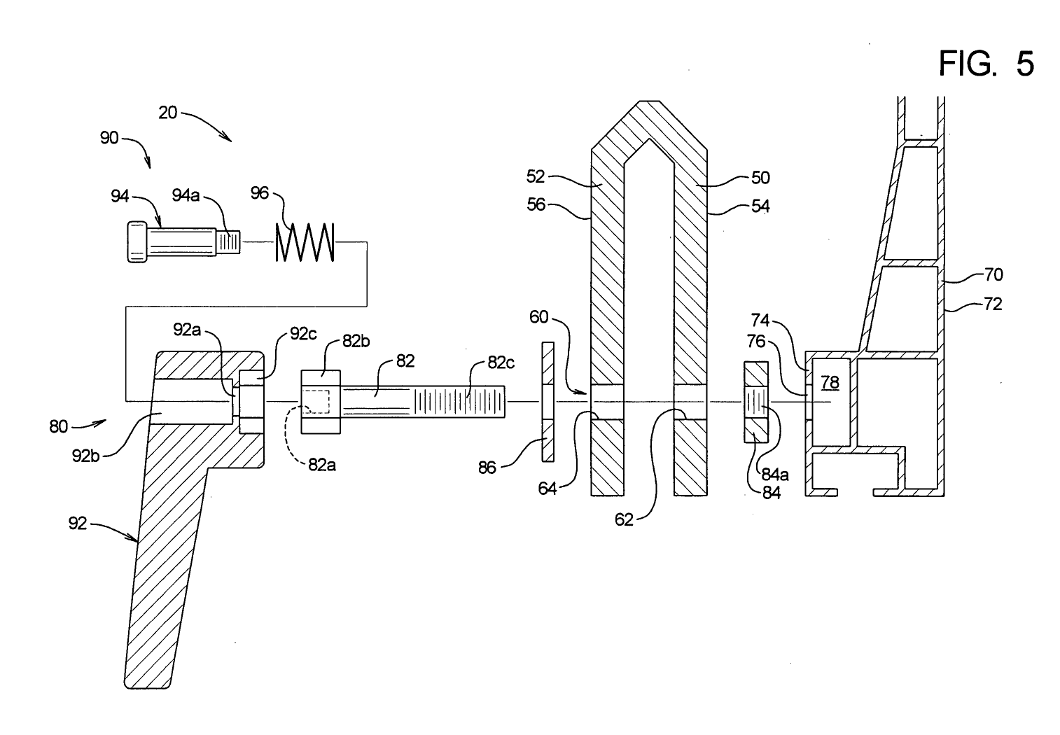

Referring now for a moment to FIG. 5, the example extension fence assembly 20 will now be described in further detail. The extension fence assembly 20 comprises an extension fence member 70. The example extension fence member 70 is an extruded piece of aluminum defining at least an extension guide surface 72, a lock wall 74, a lock slot 76, and a lock cavity 78. The extension fence member 70 may comprise other components to enhance the rigidity of the extension fence member 70,

The extension guide surface 72 defines a height dimension H_{EG} (FIGS. 2 and 3) orthogonal to the table surface 32 that is greater than a similar height dimension H_{TG} of the guide surfaces 54 and 56 of the table fence member 44. The extension guide surface 72 further defines a length dimension L_{EG} (FIG. 2) in the cutting direction A. The length dimension L_{EG} associated with the example extension fence member 70 is at least as long as a similar dimension L_{TG} (FIG. 2) of the fence member 44. The extension guide surface 72 is thus sized and dimensioned to extend much higher than and at least as long as the similar guide surfaces 54 and 56 of the table fence member 44. The extension guide surface 72 thus stably supports workpieces having a relatively narrow lateral dimension (away from the guide surface) and a relatively tall height dimension (away from the table surface).

The lock wall 74 also defines a height dimension H_{EL} (FIGS. 2 and 3) orthogonal to the table surface 32. The example height dimension H_{EL} is less than the height dimension H_{TG} of the guide surfaces 54 and 56. The lock wall 74 further defines a length dimension L_{EL} (FIG. 2) in the cutting direction A. The length dimension L_{EL} associated with the example extension fence member 70 is substantially the same as the length dimension L_{EG} (FIG. 2) of the extension fence member 70 and as the length dimension L_{TG} (FIG. 2) of the table fence member 44.

The lock slot 76 is formed in and extends the entire length L_{EL} of the lock wall 74. The lock slot 76 allows communication with the lock cavity 78 through the lock wall 74. As shown in FIG. 3, a height dimension H_{LS} of the lock slot 76 is less than a height dimension H_{LC} of the lock cavity 78.

The extension fence assembly 20 further comprises a lock assembly 80 comprising a lock bolt 82, a lock plate 84, and a lock washer 86. A diameter of the lock bolt 82 is slightly less than the height dimension H_{LS} of the lock slot 76; the diameter of the lock bolt 82 is also slightly less than the cross-sectional areas of the mounting openings 62 and 64.

The lock plate 84 defines a length dimension L_{LP} and a height dimension H_{LP} (FIG. 2). The length dimension L_{LP} is greater than the height dimension H_{LP}, and both dimensions L_{LP} and H_{LP} are greater than the height dimension H_{LS} of the lock slot 76. The height dimension H_{LP} of the lock plate 84 is less than the height dimension H_{LC} of the lock cavity 78, while the length dimension L_{LP} of the lock plate 84 is greater than the height dimension H_{LC} of the lock cavity 78.

The example extension fence assembly 20 further comprises a handle assembly 90 comprising a handle member 92, a handle bolt 94, and a handle spring 96. The handle bolt 94 extends through a handle opening 92a in the handle member 92 to secure the handle member 92 to the lock bolt 82. The handle spring 96 is arranged between the handle bolt 94 and the handle member 92 to bias the handle member 92 towards the lock bolt 82. More specifically, the handle spring 96 is a helical spring that is arranged in a spring cavity 92b formed in the handle member 92, and the handle bolt 94 is passed through the center of the handle spring 96 and the handle opening 92a. A threaded portion 94a of the handle bolt engages a threaded cavity 82a in the lock bolt 82 to secure the handle assembly 90 onto the lock bolt 82.

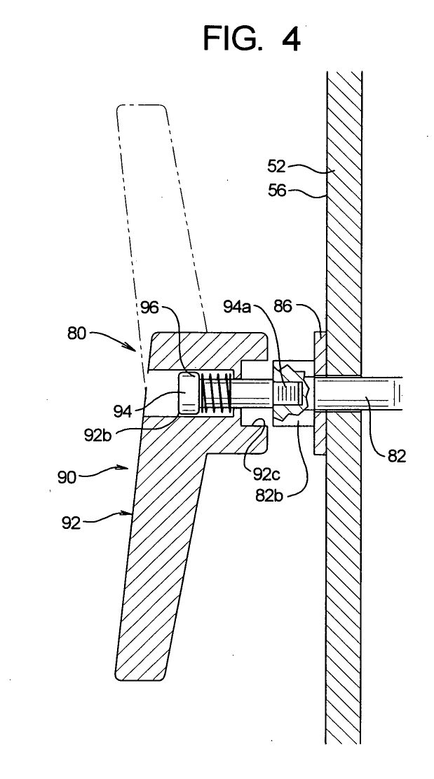

The handle spring 96 thus biases a hexagonal head portion 82b of the lock bolt 82 into a complimentary hexagonal shaped handle cavity 92c in the handle member 92. When the head portion 82b is received by the handle cavity 92c as shown in FIG. 3, the handle assembly 90 is in an engaged configuration, and rotation of the handle member 92 about the longitudinal axis of the lock bolt 82 causes axial rotation of the lock bolt 82. By displacing the handle member 92 to compress the handle spring 96 as shown in FIG. 4, however, the head portion 82b is no longer received by the handle cavity 92c, and the handle assembly 90 is in a disengaged configuration in which the handle member 92 may be freely rotated without rotating the lock bolt 82.

In use, the lock bolt 82 is inserted along the mounting passageway 60 through the lock washer 86, first mounting opening 62, and second mounting opening 64. A threaded portion 82c of the lock bolt 82 engages a threaded opening 84a in the lock plate 84. The lock plate 84 is arranged within the lock slot 76. Axial rotation of the lock bolt 82 thus causes the head portion 82b of the lock bolt 82 to force the lock washer 86 towards the second guide surface 56. The lock wall 74 is thus clamped between the lock plate 84 and the table fence member 44. Friction between the lock wall 74 and the first guide wall 50 substantially prevents relative movement between the table fence member 44 and the extension fence member 70.

The handle assembly 90 facilitates axial rotation of the lock bolt 82 to secure the extension fence member 70 relative to the table fence member 44. In particular, the handle assembly 90 is placed in the engaged configuration to rotate the lock bolt 82 in either direction.

In the example extension system 20, a length of a handle portion 92d of the handle member 92 and the location of the table surface 32 prevent the handle member 92 from being rotated through an angle of 360°. The handle assembly 90 is thus placed in the engaged configuration and the handle member 92 rotated 180° to tighten or loosen the lock bolt 82 as required. The handle assembly 90 is then placed in the disengaged configuration and rotated 180° in the opposite direction. At that point, placing the handle assembly 90 back into the engaged configuration allows further rotation of the lock bolt 82 to complete tightening or loosening of the lock bolt 82.

As an alternative to the handle assembly 90 described above, the handle member 92 may be pivotably attached to the head portion 82b of the lock bolt 82. In this case, the handle member 92 may be placed into a radial position (e.g., orthogonal to the longitudinal axis of the lock bolt 82) to axially rotate the lock bolt 82. When the handle member 92 encounters the table surface 32, the handle member 92 may be rotated from one radial position through an axial position (e.g., parallel to the longitudinal axis of the lock bolt 82) and into another radial position that allows further axial rotation of the lock bolt 82. In addition, a cam surface may formed on the handle member 92 that applies an additional clamping force on the lock wall 74 when the handle member 92 is placed into a radial position.

The extension fence assembly 20 may thus easily be attached to and detached from the table fence assembly 24 to create a taller guide surface when required. The extension fence assembly 20 thus facilitates the cutting of relatively tall, narrow workpieces, but can be easily removed when a relatively tall guide surface is not required. Clearly, the extension fence assembly 20 can be attached to either side of the table fence assembly 24 as necessary for a particular cut.

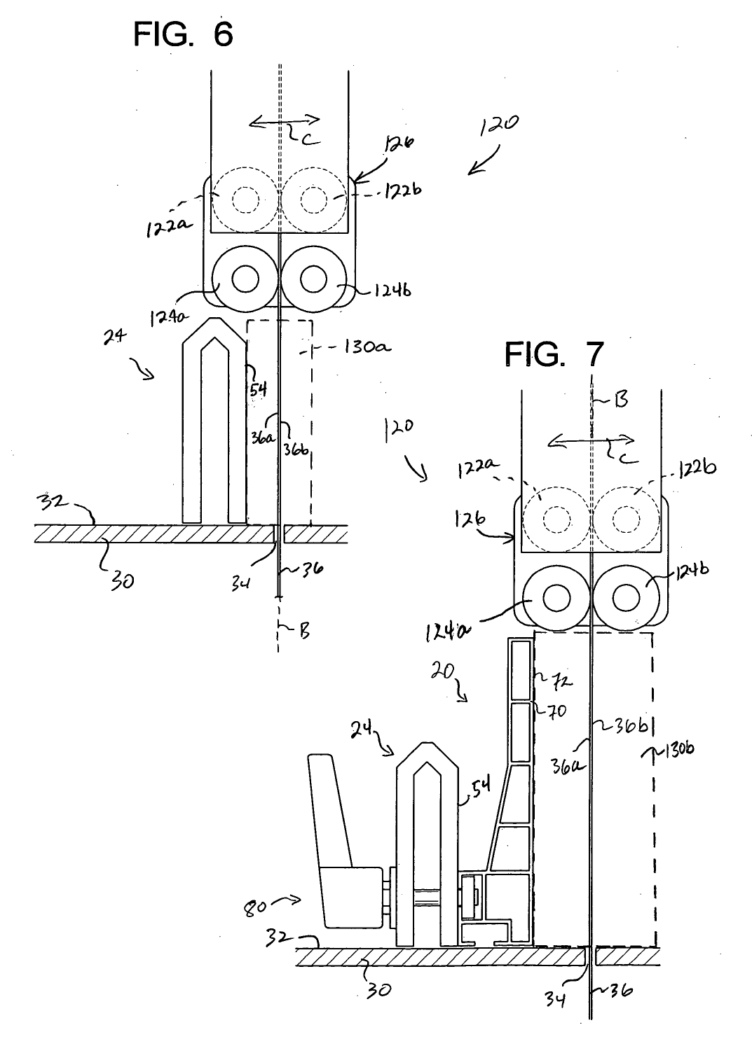

Referring now to FIGS. 6 and 7 of the drawing, those figures further illustrate the benefits of the extension fence assembly 20 in the context of the conventional band saw system 22. FIGS. 6 and 7 depict an upper is guide roller assembly 120 of the band saw system 22 that may be used to stabilize the blade 36. The upper guide roller assembly 120 comprises upper guide roller s 122a and 122b and lower guide rollers 124a and 124b arranged to contact lateral sides 36a and 36b of the blade 36. Although two guide rollers 122 and 124 are shown on each side of the blade 36 in FIGS. 6 and 7, another table saw assembly may employ one guide roller or more than two guide rollers on each side of the blade.

The guide rollers 122 and 124 are supported by a roller housing assembly 126 that is in turn supported by the band saw system 22. In particular, the band saw system 22 supports the roller housing assembly 126 for movement along the blade axis B towards and away from the table surface 32. The band saw system 22 should, however, rigidly support the roller housing assembly 126 such that, in any vertical position along the blade axis B, the guide rollers 122 and 124 substantially prevent movement of the blade 36 in a lateral direction C substantially orthogonal to both the cutting direction A and to the blade axis B.

FIG. 6 depicts a conventional situation in which only the fence assembly 24 is used to cut a workpiece 130a. The workpiece 130a is slightly taller than the height H_{TG} of the fence assembly 24. In this case, the roller housing assembly 126 is arranged such that the lower most of the guide rollers 124a and 124b are arranged immediately above the workpiece 130a or, in this case, immediately above the fence assembly 24. The use of the conventional fence assembly 24 thus allows the lower guide rollers 124a and 124b to be arranged as close as possible to the top of the workpiece 130a.

FIG. 7 illustrates the situation in which a workpiece 130b significantly taller than the height H_{TG} of the fence assembly 24 is being cut. In this case, the extension fence assembly 20 is used to support the workpiece 130b. The roller housing assembly 126 is arranged such that the lower most of the guide rollers 124a and 124b are arranged immediately above the workpiece 130b or, in this case, immediately above the extension fence assembly 20. The use of the extension fence assembly 20 thus provides significant additional support for the workpiece 130b, and the lower guide rollers 124a and 124b are arranged as close as possible to the top of the workpiece 130b.

The use of the detachable extension fence assembly 20 thus allows the band saw system 22 to be operated in a first mode with only the fence assembly 24 when shorter pieces are cut and, when taller pieces are cut, in a second mode in which the extension fence assembly 20 is attached to the fence assembly 24. In either case, the lowermost guide rollers 124a and 124b may be arranged as close as possible to the workpiece without interference by the fence assembly 24 in the first mode or by the extension fence assembly 20 in the second mode.

From the foregoing, it should be apparent that the present invention may be embodied in forms other than those described and depicted herein with departing from the scope of the present invention. The scope of the present invention should thus be determined based on the claims attached hereto and not the foregoing detailed description of the invention.

We claim:

1. A fence extension assembly for extending a height dimension of a table fence assembly, comprising:
an extension fence member defining a guide surface, a lock wall, a lock cavity, and a lock slot formed in the lock wall to allow access to the lock cavity;
a lock plate arranged within the lock cavity; and
a lock member adapted to extend through a mounting passageway in the table fence assembly and into the lock slot; whereby
the lock member engages the lock plate to rigidly secure the extension fence member to the table fence assembly.

2. A fence extension assembly as recited in claim 1, in which:
the lock member is formed by a lock bolt defining a threaded portion; and
the lock plate defines a threaded opening; whereby
the threaded portion of the lock member engages the threaded opening of the lock plate.

3. A fence extension assembly as recited in claim 2, further comprising a handle assembly for rotating the lock bolt.

4. A fence extension assembly as recited in claim 3, in which the handle assembly comprises a handle member, where the handle assembly operates in:
a first mode in which movement of the handle member causes movement of the lock bolt; and
a second mode in which movement of the handle member does not cause movement of the lock bolt.

5. A fence extension assembly as recited in claim 4, in which the handle assembly comprise a handle spring that biases the handle member towards the lock bolt.

6. A fence extension assembly as recited in claim 4, in which:
the handle member defines a handle socket; and
the lock bolt defines a head portion; whereby
the handle socket receives the head portion when the handle assembly is in the first mode; and
the head portion is not received by the handle socket when the handle assembly is in the second mode.

7. A fence extension assembly as recited in claim 6, in which the handle assembly comprise a handle spring, where the handle spring biases the handle member towards the lock bolt.

8. A fence extension assembly as recited in claim 1, in which the lock member is formed by a lock bolt defining a threaded portion, where the lock bolt engages the lock plate such that rotation of the lock bolt clamps the extension fence member to the table fence assembly.

9. A method of extending a height dimension of a table fence assembly, comprising the steps of:
providing an extension fence member defining a guide surface, a lock wall, a lock cavity, and a lock slot formed in the lock wall to allow access to the lock cavity;
arranging a lock plate within the lock cavity; and
forming a mounting passageway in the table fence assembly;
providing a lock member adapted to extend through the mounting passageway in the table fence assembly;
extending the lock member through the mounting passageway and into the lock slot such that the lock member engages the lock plate to rigidly secure the extension fence member to the table fence assembly.

10. A method as recited in claim 9, further comprising the steps of:
forming the lock member by providing a lock bolt defining a threaded portion;
forming a threaded opening in the lock plate; and
engaging the threaded portion of the lock member with the threaded opening of the lock plate.

11. A method as recited in claim 10, further comprising the step of providing a handle assembly for rotating the lock bolt.

12. A method as recited in claim 11, in which the step of providing the handle assembly comprises the step of providing a handle member, where the handle assembly operates in:
a first mode in which movement of the handle member causes movement of the lock bolt; and
a second mode in which movement of the handle member does not cause movement of the lock bolt.

13. A method as recited in claim 12, further comprising the step of biasing the handle member towards the lock bolt.

14. A method as recited in claim 13, further comprising the steps of:
forming a handle socket in the handle member;
forming a head portion on the lock bolt;
arranging the handle member such that the handle socket receives the head portion when the handle assembly is in the first mode; and
arranging the handle member such that the handle socket does not receive the head portion when the handle assembly is in the second mode.

15. A method as recited in claim 14, further comprising the step of biasing the handle member towards the lock bolt.

16. A method as recited in claim 9, further comprising the steps of:
forming the lock member by providing a lock bolt defining a threaded portion;
engaging the lock bolt with the lock plate; and
rotating the lock bolt to clamp the extension fence member to the table fence assembly.

17. A fence extension assembly for extending a height dimension of a table fence assembly, comprising:
an extension fence member defining a guide surface, a lock wall, a lock cavity, and a lock slot formed in the lock wall to allow access to the lock cavity;
a lock plate defining a threaded opening, where the lock plate is arranged within the lock cavity;
a lock bolt defining a threaded portion, where the lock bolt is adapted to extend through a mounting passageway in the table fence assembly and into the lock slot; and
a handle assembly for rotating the lock bolt; whereby
the threaded portion of the lock member engages the threaded opening of the lock plate such that rotation of the lock bolt secures the extension fence member to the table fence assembly.

18. A fence extension assembly as recited in claim 17, in which:
the handle assembly comprises a handle member defining a handle socket; and
the lock bolt defines a head portion; whereby
the handle socket receives the head portion when the handle assembly is in the first mode; and
the head portion is not received by the handle socket when the handle assembly is in the second mode.

19. A fence extension assembly as recited in claim 18, in which the handle assembly comprise a handle spring, where the handle spring biases the handle member towards the lock bolt.
